(19) United States
(12) Patent Application Publication
(10) Pub. No.: US 2006/0167706 A1
(43) Pub. Date: Jul. 27, 2006

(54) Design for outsourcing contracts

(75) Inventors: Christopher Mark Kenyon, Albis (CH); Hendrik Sebastian Lang, Zurich (CH); Giuseppe Andrea Paleologo, Riverdale, NY (US)

Correspondence Address: Gail H. Zarick;IBM CORPORATION, Intellectual Property Law Dept., P.O. Box 218, Yorktown Heights, NY, 10598, US

(73) Assignee: International Business Machines Corporation, Armonk, NY (US)

(21) Appl. No.: 11/041,135

(22) Filed: Jan. 21, 2005

(51) Int. Cl. G06Q 99/00

(52) U.S. Cl. 705/1

(57) ABSTRACT

A method suitable for generating a legal contract between an offeror and an offeree. The method comprises the steps of determining a contractual attribute utility function based on offeror preferences; determining a contractual attribute utility function based on offeree preferences; and generating a legal consideration profile by correlating the attribute utility functions based on both the offeror and offeree preferences.

### BACKGROUND OF THE INVENTION

The present invention relates to methods for designing contracts and more particularly to pricing designs for outsourcing contracts.

### INTRODUCTION TO THE INVENTION

Outsourcing of information technology (IT) infrastructure and business processes (BP) is a significant aspect of the business landscape with contract signings in the tens of billions each year for the major providers (e.g. IBM, EDS, Accenture). A recent trend is the emphasis on variable capacity contracts linked to business or IT metrics for medium to long term (2-10 year) deals. This new emphasis on variability is linked to a growth in interest in the accompanying pricing schemes.

### SUMMARY OF THE INVENTION

We have discovered that a basic tension in the design of these pricing schemes occurs between the objectives of the outsourcing provider (hereafter Provider) and the company whose IT or BP are being outsourced (hereafter Client). In other words their utility functions on contract attributes differ. For example the Client may desire utility-style pricing whilst the Provider may be interested in; the certainty with which it achieves a given margin. This tension is accentuated by the history-dependent nature of capacity costs for many contract elements, the wide range of capacities of interest to the Client, and the unpredictability of actual events over the contract lifetime. Contract elements typically include dependencies on process steps, people, hardware, and software licenses.

The inventors therefore believe there is a need for adequate contracting tools and pricing methodologies, coupled with the unique features of IT service provisioning.

Accordingly, we now disclose a method suitable for generating a legal contract between an offeror and an offeree, the method comprising the steps of:
(i) determining a contractual attribute utility function based on offeror preferences;
(ii) determining a contractual attribute utility function based on offeree preferences; and
(iii) generating a legal consideration profile by correlating the attribute utility functions based on both the offeror and offeree preferences.

Preferably, at least one of the offeror and offeree preferences comprises pricing, for example, utility pricing.

Preferably, at least one of the offeror and offeree preferences comprises certainty in order to achieve a pre-determined profit margin.

Preferably, at least one of the offeror and offeree preferences comprises variable capacity information technology infrastructure, or alternatively, a variable capacity business process.

Preferably, at least one of the offeror and offeree preferences comprises specifying a delivery method.

Preferably, at least one of the offeror and offeree preferences comprises specifying a contractual item.

As disclosed above, step iii of the method comprises generating a legal consideration profile by correlating the attribute utility functions based on both the offeror and offeree preferences. In this regard, it is an advantage of the present invention that step iii may comprise generating a legal consideration structure relative to the utility functions of at least one of the offeror and offeree preferences. For example, the step iii correlating may advantageously comprise employing a descriptive multi-attribute utility theory framework. Step iii may also advantageously comprise correlating the attribute utility functions based on history dependency.

### BRIEF DESCRIPTION OF THE DRAWING

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 illustrates a series of event spaces E₁, E₂, E₃, . . . of increasing dimension over which observed volume requirements v₁, v₂, v₃, . . . are defined, where vᵢ is the i-vector v₁, . . . , vᵢ);

FIG. 2 exemplifies a de-mean'd demand series from a SARMA model wherein the contract length is 60 months.

FIG. 3 illustrates the autocorrelation of the de-mean'd demand of FIG. 2, as a function of lag.

FIG. 4A illustrates a Granular cost state space example showing current demand volume versus previous demand volume, with cost granularity of 12.5% of the demand range.

FIG. 4B illustrates a Granular+Lag cost state space example showing current demand volume versus previous demand volume, with cost granularity of 12.5% of the demand range.

FIG. 4C illustrates a Granular+Change cost state space example showing current demand volume versus previous demand volume, with cost granularity of 12.5% of the demand range.

FIG. 4D illustrates a Granular+Change+Lag cost state space example showing current demand volume versus previous demand volume, with cost granularity of 12.5% of the demand range.

FIG. 5 illustrates cost per unit as a function of volume for four different cost granularities: 12.5% (+), 25% (x), 50% (Δ) and 100% (□).

FIG. 6 illustrates pareto-optimal utility frontiers for three different price designs—Linear, Certain and Cost Plus—specified by changing the weights in the utility functions.

FIG. 7 illustrates the effect of contract length on difference in expected contract price for Linear and Certain pricing versus Cost Plus prices.

FIG. 8 illustrates optimal price per unit as a function of volume for cost granularity of 25% with zero cost to change (dashed line) and a cost to change of 4 (curve with error bars). The horizontal line at 100% indicates optimal linear prices.

FIG. 9 illustrates expected contract prices with optimal cost plus prices (black line with +symbol) and optimal linear prices (black line with no, symbols) as a function of cost granularity.

FIG. 10 illustrates the dependence of expected contract price on the cost to change the delivery level for linear pricing relative to cost plus price.

FIG. 11 illustrates the relationship between increased expected contract price for linear pricing versus the coefficient of variation of the Provide margin with linear pricing. Test cases shown include different costs to change, zero lag and unit lag.

### DETAILED DESCRIPTION OF THE INVENTION

In an illustrative embodiment, the present invention characterizes and solves the price design problem (“PDP”) for variable capacity IT/BP outsourcing contracts within a descriptive multi-attribute utility theory framework from the point of view of the bid team, i.e., they know costs and can negotiate prices. The utility functions of the Provider and the Client aim to represent the actual preference structure of the decision makers taking into account attributes of the price design and its expected consequences over the contract lifetime. Descriptive utility functions find support in the empirical research on individual decision making, explicit bid evaluation descriptions in RFPs (request for proposals) (Beil & Wein 2003), and explicit documentation in corporate bid sheets. Multi-attribute utility includes these aspects and has been used in many types of cases such as, for example, disposition of plutonium (Dyer, et al. 1998). Our objective functions also allow us, for example, to recover the instance of risk-neutral decision makers.

According to a preferred embodiment of the invention, both costs and prices are modeled as path dependent discontinuous non-linear functions of capacity. Path dependent cost structures are important because this reflects the typical history dependence of costs for changing service levels in IT and BP outsourcing. Granular non-linearity in costs models the fact that capacity costs to achieve service levels often come in integer multiples, e.g., n servers or m full time equivalent developers/operators/etc. History dependent prices are required to be able to model cost-plus contracts. The method of the invention may include side constraints to prevent unreasonable price structures, i.e., arbitrage, as required. Preferably, the method, of the invention finds the optimal, potentially history dependent, pricing structure relative to the utility functions of both the Provider and the Client.

According to a preferred aspect of the present invention, the Provider's capacity changes dynamically in response to observed demand; additionally prices and costs both are path (i.e. history) dependent.

The price design problem, i.e., the problem of choosing a price structure to optimize the joint utility function of the Provider and of the Client, may be formulated as a stochastic program. As disclosed herein, the invention preferably uses a formulation method based on decomposition of the event space (where events are, e.g., Client requirement histories), preferably using a basis of linear functionals (e.g., Chebyshev or Fourier series). Depending on the form of the utility functions the price design problem may be reducible to: a Stochastic Linear Program (SLP); a Stochastic Linear Mixed Integer Program (SLMIP); or a Stochastic Quadratic Mixed Integer Program (SQMIP). This problem may be solved numerically using software. The solution yields Pareto-efficient outcomes with respect to the Provider and the Client. These solutions lead directly to the construction of a pareto-efficient frontier of price designs with axes of Provider-utility and Client-utility. This frontier serves as an appropriate space for practical contract negotiation.

### Method

We now present a rigorous derivation of a general formulation of the price design problem, using notation as follows:

| | |
|---|---|
| U_{T} | total utility of contract |
| U_{C} | contract utility for the Client |
| U_{P} | contract utility for the Provider |
| E_{P\|C}[ ] | expectation w.r.t. Provider\|Client probabilities |
| (...)⁺ | positive part |
| α, β, ξ, [symbol] | constants |
| n | number of measurement/billing periods in contract |
| vᵢ | service volume requirement at time point i |
| vₘₐₓ | maximum contract volume considered |
| vₘᵢₙ | minimum contract volume considered |
| vᵢ^{d} | service volume delivered at time point i |
| vᵢ | service volume requirements history up to time point i |
| vᵢ^{r} | r th realization of vᵢ |
| r = 1, ..., R | index of realizations R |
| vᵢ^{m} | m th realization of vᵢ (potentially different from |
| | the above) |
| m = 1, ..., M | index of realizations M |
| vᵢ^{d} | service volumes delivered up to time point i |
| pᵢ(vᵢ) | price charged by Provider to Client at time point i |
| cᵢ(vᵢ) | Provider's cost |
| aᵢ(vᵢ) | ideal price, or price structure, from Client point of view |
| Eᵢ | i-dimensional space [vₘᵢₙ, vₘₐₓ]ⁱ |
| L_{i,j} | basis element j for functions over Eᵢ |
| K_{i,j} | alternative to above |
| g_{i,j} | scalar coefficients of basis elements |
| h_{i,j} | alternative to above |
| I(*) | indicator function on the condition *, e.g. meeting a |
| | threshold |
| wₐ, wₜ wᵣ, | weights in Provider utility function of no-arbitrage, |
| wₗ, wₕ | VaR threshold, and expected return |
| wₚ, w_{d}, | weights in Client utility function of expected price, |
| wₛ, wᵤ | price deviation, price smoothness, and under-delivery |
| X, Y, L, H, lᵣ, | real decision variables |
| hᵣ, x_{m,i}, y_{m,i} | |
| b(r), B | binary decision variables |

One objective of the optimization is to obtain the pareto-efficient (or pareto-optimal) frontier of pricing structures with respect to the Client and Provider utilities, U_{C} and U_{P} respectively. These solutions maximize the total contract utility U_{T}=λU_{C}+μU_{P} for some positive weights λ and μ. The simplest method to obtain this frontier is to solve the following optimization problem for varying ξ
max U_{C}s.t.U_{P}≧ξ (1)
where the decision variables are the prices.

Assumptions: The assumptions we generally follow are as follows:

1. Single client. There may be multiple entities within the Client but we do not consider them explicitly. We specifically exclude consideration of resource sharing across multiple clients for the Provider.

2. Demand does not depend upon price. This is a strong assumption in that it does not model the client's incentive to add new services to the contract scope after the start. However, this is a realistic frame for the outsourcing problem in practice.

3. Single service. We do model multiple components within the service considered (e.g. people, hardware, software) but we do not consider resource sharing across multiple services. This is reasonable in as much as the services are distinct (e.g. mainframe support versus application help desk).

4. Myopic service fulfillment policy. The Provider attempts to fulfill the service level required by the Client considering the current service level and its history but without optimizing delivery capability relative to future requirements. This is a suboptimal strategy but delivery optimization is not the focus of the current work.

5. Single pricing schedule decision at start of contract. After the contract start the pricing schedule is not changed although clearly different prices are charged for different delivery levels over the life of the contract based on the pricing schedule.

6. Lags in costs, delivery, or prices are integer multiples of contract measurement/billing intervals. This assumption is not strictly necessary but is useful for simplicity of problem formulation.

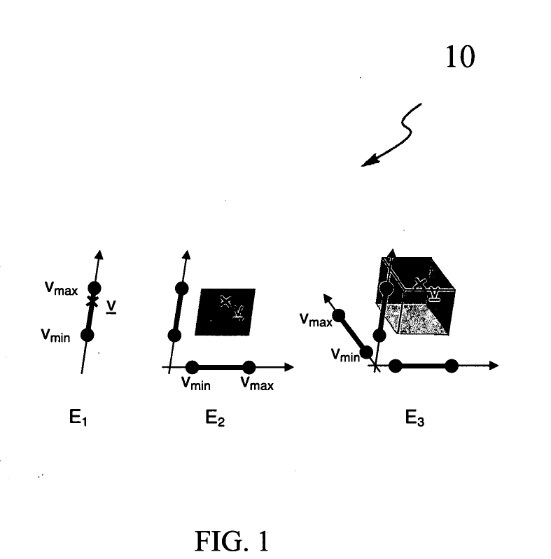

Events and Probabilities: With reference now to the drawings, FIG. 1 illustrates a series of event spaces E₁, E₂, E₃, . . . of increasing dimension over which observed volume requirements v₁, v₂, v₃, . . . are defined, where vᵢ is the i-vector (v₁, . . . , vᵢ). The volume requirements history of the contract is {vᵢ|i=1, . . . , n} where there are n measurement/billing points in the contract, e.g. monthly billing for 5 years would give n=60.

Assume the contract is measured/billed at n time points that we index by i, i=1, . . . , n. Let us assume that the contract is defined so that the only relevant volume levels are in the closed interval [minᵢ, maxᵢ] for each time point and without loss of generality we assume that minᵢ=minⱼ, ∀i, j and maxᵢ=maxⱼ, ∀i, j. Let Eᵢ=[min,max]ⁱ be spaces of dimension i=1, . . . , n and that (E₁, . . . Eₙ) forms an increasing series such that Eᵢ∩Eⱼ=E_{min(i,j)}. FIG. 1 (numeral 10) illustrates the start of this series for i=1, 2, 3.

We define the information structure on Eᵢ, i=1, . . . , n induced by the stochastic process of the volume history as Fᵢ, i=1, . . . , n the filtration on Eᵢ. The probability P on F=∪Fᵢ is defined as the natural probability induced by the stochastic process of the volume history. Let ∪Ωᵢ=Ω. Thus we have a probability space (Ω, F, P).

When costs and prices are functions of the complete history, then iₘₐₓ=n the number of billing/measurement points in the contract. However when prices and costs are only functions of a limited history, e.g. only involve lagged demand up to a given point, or can be expressed as a function of a state expansion where this dimension is less than n then iₘₐₓ<n. If prices are required to be a function of time, e.g. decrease according to a given schedule, then this increases the previous iₘₐₓ by one. In practice only a limited history (amount of state information) is required so typically iₘₐₓ<<n.

Costs and Prices: We assume that the cost cᵢ at each time point i is an arbitrary deterministic function of the volume history, i.e. it is an element of the Hilbert space L²(Eᵢ,R). Thus cᵢ(vᵢ) is a function on Eᵢ (potentially different for each i), where i can run from 1 to iₘₐₓ=n. However as mentioned above usually iₘₐₓ<<n.

Note that cᵢ is not required to be equal to cⱼ, i≠j, on Eᵢ∩Eⱼ=E_{min(i,j)}. Indeed this will generally not be the case because this would imply vₖ=0, k=min(i,j)+1, . . . , k=n i.e. these are the costs realized for contract effective termination with effect at time min(i,j)+1. This can be an event with non-vanishing probability if the stochastic process describing the volume requirement history includes this possibility (e.g. includes modeling of Client failure, contract cancellation, etc.). Thus costs are a vector of functions cᵢ on Eᵢ, which we write c. We place no restrictions on cost functions.

We define the price pᵢ at each time point i as an element of the Hilbert space L²(Eᵢ,R). This means that prices have the same generality as costs, i.e. pᵢ(vᵢ) is an arbitrary deterministic function over Eᵢ. Thus the contract price is a vector of functions pᵢ on Eᵢ, written p.

Let us pick a differentiable (i.e. C¹) orthonormal basis for L²(Eᵢ,R), say L_{i,j}, j=1, . . . , ∞ (where ∞=χ₀). For example L_{i,j} could be the i-dimensional Fourier series (suitably coded so that the frequencies in different dimensions reduce to one index, namely j). Clearly for all practical purposes we can truncate the series at jₘₐₓ for some suitable value, and without loss of generality we can take this value to be the same for all i=1, . . . , iₘₐₓ.

Now we define the price pᵢ as the linear functional

$${p}_{i} = {\sum }_{j = 1}^{j = {j}_{max}} {g}_{i , j} {L}_{i , j} \qquad ( 2 )$$

and by choosing jₘₐₓ sufficiently large we can approximate any (sensible, i.e. finite number of discontinuities) price arbitrarily closely by choosing appropriate a_{i,j}.

By expressing prices in this way we have placed essentially no restrictions on their form. However there is a common sense restriction that can be added:
pᵢ(v₁, . . . , vᵢ)≦pᵢ(v₁, . . . , vᵢ)∀vᵢ≦vᵢ (3)
i.e. price never decreases with increasing volume. If this restriction were not in place potential arbitrage-creating prices would be possible. That is, if prices decrease with volume there is the possibility that the Client will increase usage and sell the extra capacity. This does violate assumption 2 above, but it is useful in practice if it is seen that such prices occur.

Demand Models: The aim of a demand model is to model future forecast demand. Future demand may bear no relation to past demand: indeed this is the objective when new services are being set up. In these cases the future demand model expresses the opinion of the Provider and/or the Client. Whether these opinions are the same or are different, the contract price utility optimization framework presented accommodates both cases directly. In the current framework any demand forecasting method can be used and this is simple because we have assumed that demand does not depend on price. Here we will use the Box-Jenkins time-series framework for examples, although a person of skill in the art will recognize many other possibilities.

Note that the formulation of the optimization problem and its solution do not depend on the details of the demand models—it is sufficient that they can be simulated. Whether this is via Box-Jenkins or from a proprietary demand planning model is irrelevant.

Delivery Model: We have assumed (see Assumptions above) myopic service fulfillment (delivery). That is, delivery is done as well as possible but with no optimization with respect to future forecast demands. Thus for some services, or service components, demand may not be satisfied immediately, i.e. there is under-delivery. In practice, with or without forecasting, there may be lags in service satisfaction. Note also that it is possible for delivery to be immediate and for costs to be lagged. This is typical for decreasing delivery situations and can also occur, but more rarely for increasing delivery situations.

Under-delivery is discussed in more detail below (under Client Utility and Discussion). It suffices to note here that under-delivery is history dependent; it is implicitly included in the Provider utility function (described below), and explicitly included in the Client utility function (described thereafter).

Descriptive Utility Modeling: Here we will describe the descriptive utilities for the Provider and for the Client. In different situations not only will the weights on different elements of descriptive utility functions be different but also some of the elements will not be present (i.e. weight of zero). In fact there are as many valid alternatives as there are different specifications in RFQs and Corporate Bid Sheets.

Provider Utility: We build up the utility function of the Provider based on contract-level preferences and preferences such as:
1. There are a set of financial thresholds that a contract must meet in order to be acceptable under the rules of the finance department.
2. Once thresholds are met a contract is judged on its expected return.
3. For a given expected contract value chances of lower margins are viewed less favorably chances of higher margins.
4. No arbitrage possibilities should be present in a single time period. (Recall Equation 3 above).

We preferably model the thresholds as an indicator function on a value at risk (VaR) type criteria. Whilst VaR has various difficulties as a risk measure (e.g. lack of coherence (Artzner, et al. 1999, Riedl 2003)) it is applicable here in describing the attitude of many finance departments that wish to control “worst case” scenarios on an individual contract basis and do not combine risks from different contracts. The optimization method that follows below (see, “General Formulation”) can be, easily adapted to other risk measures, e.g. conditional value at risk, that are coherent. When prices are cost-plus, i.e. costs plus an agreed margin, then there is no worst case—the margin is certain. Cost-plus contracts are unusual but do occur. Of course the objective of the optimization is to find the best trade-off between cost-plus at one extreme and an offered price-volume (or price-volume-time considering efficiency increases in hardware, etc.) curve at the other.

$${U}_{P} ( \underline{p} ) = - {w}_{t} I ( P [ R ( \underline{p} ) < α ] > β ) + {w}_{r} {E}_{P} [ R ( \underline{p} ) ] - {w}_{l} {E}_{P} [ {( Ξ - R ( \underline{p} ) )}^{+} ] + {w}_{h} {E}_{P} [ {( R ( \underline{p} ) - Ξ )}^{+} ] - {w}_{a} {\sum }_{i = 1}^{i = n} {\int }_{[ {v}_{min} , {v}_{max} ]}^{} I ( \partial {p}_{i} ( {\underline{v}}_{i} ) / \partial {v}_{i} < 0 ) ⅆ {v}_{i} \qquad ( 4 )$$

The expectation is taken with respect to the filtration F, as determined by the Provider, i.e. F_{P}. The probabilities are similarly defined. The utility weighting parameters wₐ, wₗ, wₕ, wₜ are all non-negative.

The parts of the function above are written in the same order to the list of ideas upon which they are based.

The first term computes the probability that the contract return R is less than the threshold α for the set of price functionals p defining the contract price.

The second term is simply the expected contract return.

The third line calculates the expected returns below and above a given target, Ξ, and weights them differently. Returns below the target will be penalized and those above rewarded. This term is vital in that it establishes Provider price preferences, i.e. in the absence of Client price preferences it pushes Provider prices to be cost plus margin where this equals a return of Ξ. Prices will try not to go lower and the overall Client preference for a low expected price (which generally dominates) will push them down to this value. The VaR type constraint (first term) is insufficient to establish Provider price preferences: this complementary term is necessary for this.

The last line says that for every time point i the price should increase with volume at that time period. The purpose of the integral is to scan over the possible volume range [vₘᵢₙ, vₘₐₓ] and the sum scans over all the time points. If this condition is ever violated the indicator function is 1 and then this violation is weighted by wₐ.

Provider utility function characteristics:

If wₐ=wₕ=wₗ=wₜ=0 then the Provider is risk neutral and has no preference on the form of the prices. Thus any prices resulting in the same expected value are acceptable to the Provider—including a lump sum on day one and no payments thereafter.

Generally wₐ=wₜ=∞ i.e. no-arbitrage must be present, and the risk threshold must be observed.

Client Utility: The Client utility function is based on three ideas.

1. Expected price of the contract.

2. Predictability of the price for a given service volume.

3. The degree to which demand is not met.

We preferably model the descriptive utility of price predictability in two parts: a) the deviation of the actual observed price-volume points from an ideal price-volume curve; b) a price smoothness term measuring the rate of change of unit price with volume and with volume-history.

We ignore unmet demand for the moment, thus prices depend only on the volume history of requirements (not delivery to requirements which we include below):

$${U}_{C} ( \underline{p} ) = {w}_{p} {E}_{C} [ {\sum }_{i = 1}^{i = n} {p}_{i} ( {v}_{i} ) ] - {w}_{d} {\sum }_{i = 1}^{i = n} {E}_{C} [ {d}_{v} ( {p}_{i} ( {v}_{i} ) / {v}_{i} , {a}_{i} ( {v}_{i} ) ) ] - {w}_{s} {E}_{C} [ {\sum }_{i = 1}^{i = n - 1} {d}_{t} ( p ( {v}_{i} ) / {v}_{i} , p ( {v}_{i + 1} ) / {v}_{i + 1} ) ] \qquad ( 5 )$$

The expectations are taken with respect to the filtration F, as determined by the Client, i.e. F_{C}. The utility weighting parameters wₚ, w_{d}, wₛ are all non-negative. The first term in the descriptive Client utility function is the expected contract price. The second term measures the deviation of the observed unit prices from the Client's ideal unit price at each time point i (thus ideal prices can be time dependent). Note that there are two alternative specifications of this term depending on whether aᵢ(vᵢ) is a fixed function or a fitted function. By a fixed function we mean one whose coefficients are known and fixed. By a fitted function we mean one whose coefficients are themselves variables. To make this clear consider the following example.

For this example we take just look at the first two terms of Equation 5 and take dᵥ to be the L² norm for simplicity. Thus we have:

$${U}_{C} ( \underline{p} ) = {w}_{p} {E}_{C} [ {\sum }_{i = 1}^{i = n} {p}_{i} ( {v}_{i} ) ] - {w}_{d} {\sum }_{i = 1}^{i = n} {E}_{C} [ {( {p}_{i} ( {v}_{i} ) / {v}_{i} - {a}_{i} )}^{2} ) \text{]} \qquad ( 6 )$$

Where we have also replaced aᵢ(vᵢ) by aᵢ and we consider aᵢ to be a real variable. The effect of this substitution will be to force the optimization (maximizing U_{C}) to find the best least squares fit to the price data points pᵢ(vᵢ)/vᵢ and then to penalize deviations from it. In other words the Client wants a linear price volume curve that goes through zero but, taking also into account the expected contract price, does not have a preference for what the slope is. This is a trivial example and we can modify U_{C} slightly more to make the power of this approach more visible. Consider a modified U_{C} as follows.

$${U}_{C} ( \underline{p} ) = {w}_{p} {E}_{C} [ {\sum }_{i = 1}^{i = n} {p}_{i} ( {v}_{i} ) ] - {w}_{d} {\sum }_{i = 1}^{i = n} {E}_{C} [ {( {p}_{i} ( {v}_{i} ) - ( {a}_{i} \times {v}_{i} + {b}_{i} ) )}^{2} ] \qquad ( 7 )$$

where we have taken aᵢ(vᵢ) to be aᵢ×vᵢ+bᵢ, and used price rather than price per unit in the second term of U_{C}. This now says that the Client wants linearity of price but does not insist that the price for zero volume be zero. That is, there can be a minimum price what ever the volume is. The fitted function aᵢ( ) is influenced by the other terms and so will not be the same as the unconstrained fit of such a function. However this approach to aᵢ( ) as a fitted function rather than as a fixed function adds an extra degree of expressiveness can be useful.

The third term measures the deviation of (unit) prices from each other over time along volume histories. This penalizes observable unit price changes. It might appear desirable to combine this term with the previous term. However the increased generality would not be readily observable either in contract language (a direct statement of such a general term would be meaningless to most decision makers) or in experience over a contract history.

We stress unit prices in the utility function based on the argument that changes in price arising from changes in volume of a services used are generally acceptable. If this is not the case it is simple to modify the utility function to operate on total prices rather than unit prices.

Client utility function characteristics:

If w_{d}=wₛ=0 then only the expected price of contract important, i.e. the Client is risk neutral.

If w_{d} high (a≠0) certainty of unit price and distance from Client ideal both important.

If wₛ high then smoothness of price per unit over contract history is important.

When we include the consideration of unmet demand (under-delivery, see “Discussion,” below) in the Client utility function we need to add a further term quantifying the (dis-)utility of unmet demand to the Client per contract history, shown below.

$$- {w}_{u} {E}_{C} [ {\sum }_{i = 1}^{i = n} {d}_{u} ( {v}_{i} , {v}_{i}^{d} ) ] \qquad ( 8 )$$

We make use of vᵢ^{d} the volume requirements actually delivered. Note that the vᵢ terms in the prices terms in the utility functions also need to be modified to be the minimum of required and delivered. This is because we expect Clients to pay for what is delivered rather than what they require.

General Formulation: In this section we first assemble an analytic formulation of the price design problem (PDP). We then transform the analytic formulation into a form suitable for practical calculations.

The analytic formulation of the price design problem (PDP) can be assembled by re-writing Equation 1 using the expressions we have developed for the Provider and Client utility functions, Equations 4 and 5 respectively. Thus we have:

$$\begin{matrix}{max}_{ \underline{v}} {w}_{p} {E}_{C} [ {\sum }_{i = 1}^{i = n} {p}_{i} ( {\underline{v}}_{i} ) ] - {w}_{d} {\sum }_{i = 1}^{i = n} {E}_{C} [ {d}_{v} ( {p}_{i} ( {\underline{v}}_{i} ) / {v}_{i} , {a}_{i} ( {\underline{v}}_{i} ) ) ] - {w}_{s} {E}_{C} [ {\sum }_{i = 1}^{i = n - 1} {d}_{t} ( p ( {\underline{v}}_{i} ) / {v}_{i} , p ( {\underline{v}}_{i + 1} ) / {v}_{i + 1} ) ] \\ s . t . & ( 9 ) \\ - {w}_{t} I ( P [ R ( \underline{p} ) < α ] > β ) + {w}_{r} {E}_{P} [ R ( \underline{p} ) ] - {w}_{l} {E}_{P} [ {( Ξ - R ( \underline{p} ) )}^{+} ] + {w}_{h} {E}_{P} [ {( R ( \underline{p} ) - Ξ )}^{+} ] - {w}_{a} {\sum }_{i = 1}^{i = n} {\int }_{[ {v}_{min} , {v}_{max} ]}^{} I ( \partial {p}_{i} ( {\underline{v}}_{i} ) / \partial {v}_{i} < 0 ) ⅆ {v}_{i} \geq ξ & ( 10 )\end{matrix}$$

That is, maximize the Client utility as a function of the vector of price functions v such that the Provider utility is greater than or equal to ξ.

We now transform this analytic formulation into one suitable for practical calculations.

Now wₐ=∞, i.e. no arbitrage must ever be present in the prices at the given time point i so we can separate this term into a set of separate constraints because it must always hold. Thus Equation 10 becomes:
∫_{[v}_{ₘᵢₙ}_{,v}_{ₘₐₓ}_{]}I(∂pᵢ(vᵢ)/∂vᵢ<0)dvᵢ=0∀i

Which is equivalent to the constraints:
∂pᵢ(vᵢ)/∂vᵢ≧0∀i=1, . . . , n, ∀vᵢ∈[vₘᵢₙ,vₘₐₓ]

Note that by construction (Equation 2) we can express the price as a finite sum (of fixed length) of differentiable functions. Additionally if we take the basis to be either Fourier or Chebyshev (over i-dimensions), these are differentiable analytically. However, if we had retained an infinite series representation this term-by-term differentiation (i.e. exchange of differentiation and summation) would only be valid if the resulting infinite series was uniformly convergent.

Equation 9 is an indicator relative to an integral over the space of sample paths (i.e. over the contract volume histories), i.e. this term can be re-written as

$${w}_{t} I ( P [ \frac{{\sum }_{i = 1}^{i = n} {p}_{i} ( {\underline{v}}_{i} )}{{\sum }_{i = 1}^{i = n} {c}_{i} ( {\underline{v}}_{i} )} < α ] > β )$$

The inner probability calculation is an integral over Eₙ, thus we have

$${w}_{t} I ( {\int }_{{E}_{n}}^{} I ( \frac{{\sum }_{i = 1}^{i = n} {p}_{i} ( {\underline{v}}_{i} )}{{\sum }_{i = 1}^{i = n} {c}_{i} ( {\underline{v}}_{i} )} < α ) ⅆ F ( \underline{v} ) > β )$$

We can calculate the integral by Monte Carlo integration and introducing a binary decision variable b for each point sampled in Eₙ to model the indicator variables within the integration. We can also replace the outer indicator function with a binary decision variable B. Assume that we take R sample paths v^{r},r=1, . . . , R thus we have R+1 new decision variables b(r) and B. The formula above thus separates into the following constraints and a term wₜB in the comparison versus ξ.

$$- β + \frac{1}{R} {\sum }_{r = 1}^{r = R} b ( r ) \leq B \times BIG$$

$$α - \frac{{\sum }_{i = 1}^{i = n} {p}_{i} ( {\underline{v}}_{i}^{r} )}{{\sum }_{i = 1}^{i = n} {c}_{i} ( {\underline{v}}_{i}^{r} )} \leq b ( r ) \times BIG ∀ r = 1 , … , R$$

The second term of the Provider utility represents the expected contract return (price/cost). There are many ways to calculate this integral depending on the form of the probability function on the Eᵢ induced by the stochastic process for volume. If we decompose the probability function into a (truncated) series of linear functionals, then the integral can be calculated analytically simply by convolving the two series then integrating term by term. However, for simplicity we will use Monte Carlo integration. Note, though, that the number of samples M used for the integration here does not need to be the same as that used elsewhere (i.e. we can have M≠R).

We can take the functions d_{*}(,) to be either the L² norm, resulting in a Quadratic Program or the L¹ norm resulting in a Linear Program. Choosing d_{*}(,) as the positive semi-deviation would also result in a Linear Program. The positive semi-deviation can be motivated by the idea that only prices above Client ideal should be penalized and also that the Client desires unit prices that go down over time. Alternatively the Client may desire price predictability, given that expected price is already captured, and hence penalize deviations on both sides.

We give the L² norm formulation here and the L¹ norm formulation in the Appendix. Whilst the L² norm formulation is cleaner and more compact we found the L¹ norm formulation faster and more convenient to modify in practice. It is also the one we used in the worked example, below (see “Example” section below). We calculate expectations with Monte Carlo integration.

$$X = \frac{1}{M} {\sum }_{m = 1}^{m = M} {\sum }_{i = 1}^{i = n} {( {p}_{i} ( {\underline{v}}_{i}^{m} ) / {v}_{i} - {a}_{i} ( {\underline{v}}_{i}^{m} ) )}^{2}$$

$$Y = \frac{1}{M} {\sum }_{m = 1}^{m = M} {\sum }_{i = 1}^{i = n - 1} {( {p}_{i} ( {\underline{v}}_{i}^{m} ) / {v}_{i} - {p}_{i + 1} ( {\underline{v}}_{i + 1}^{m} ) / {v}_{i + 1} )}^{2}$$

Recall that we can approximate pᵢ as a sum of linear functionals (Equation 2). Thus, putting all of this together we arrive at the following formulation (with the L² norm).

$${max}_{{g}_{i , j}} \frac{1}{M} {\sum }_{m = 1}^{m = M} {\sum }_{i = 1}^{i = n} {\sum }_{j = 1}^{j = {j}_{max}} {w}_{p} {g}_{i , j} {L}_{i , j} ( {\underline{v}}_{i}^{m} ) + {{w}_{d} ( {g}_{i , j} {L}_{i , j} ( {\underline{v}}_{i}^{m} ) / {v}_{i} - {a}_{i} ( {\underline{v}}_{i}^{m} ) )}^{2} + {{w}_{s} ( {g}_{i , j} {L}_{i , j} ( {\underline{v}}_{i}^{m} ) / {v}_{i} - {g}_{i + 1 , j} {L}_{i + 1 , j} ( {\underline{v}}_{i + 1}^{m} ) / {v}_{i + 1} )}^{2} \\ s . t . \\ ξ \leq {w}_{r} \frac{1}{M} {\sum }_{m = 1}^{m = M} {\sum }_{i = 1}^{i = n} {\sum }_{j = 1}^{j = {j}_{max}} {g}_{i , j} {L}_{i , j} ( {\underline{v}}_{i}^{m} ) - {w}_{t} B - {\sum }_{r = 1}^{r = R} ( {w}_{l} {l}_{r} - {w}_{h} {h}_{r} ) \\ Ξ = {l}_{r} - {h}_{r} + \frac{{\sum }_{i = 1}^{i = n} {\sum }_{j = 1}^{j = {j}_{max}} {g}_{i , j} {L}_{i , j} ( {\underline{v}}_{i}^{r} )}{{\sum }_{i = 1}^{i = n} {c}_{i} ( {\underline{v}}_{i}^{r} )} \\ B ⨯ BIG \geq - β + \frac{1}{R} {\sum }_{r = 1}^{r = R} b ( r ) \\ b ( r ) ⨯ BIG \geq α - \frac{{\sum }_{i = 1}^{i = n} {\sum }_{j = 1}^{j = {j}_{max}} {g}_{i , j} {L}_{i , j} ( {\underline{v}}_{i}^{r} )}{{\sum }_{i = 1}^{i = n} {c}_{i} ( {\underline{v}}_{i}^{r} )} \\ {\sum }_{j = 1}^{j = {j}_{max}} {g}_{i , j} {L}_{i , j} ( {\underline{v}}_{i}^{r} ) \geq 0 ∀ i = 1 , … , n , ∀ r = 1 , … , R \\ {a}_{i} ( {\underline{v}}_{i} ) = {\sum }_{j = 1}^{j = {k}_{max}} {h}_{i , j} {K}_{i , j} ( {\underline{v}}_{i} ) \qquad ( 11 )$$

where the h_{i,j} are now real decision variables and the K_{i,j} are functions that express the shape of the unit price versus volume curve that the Client desires. Note that generally K_{i,j}≠L_{i,j}. If they were equal this would say that, because the L form a basis of Eᵢ, the client does not care what shape the price volume curve is. This can be accomplished more easily by setting w_{d}=0.

This formulation with the L¹ norm is a SLMIP and with the L² norm is a SQMIP. There are R+1 binary variables, i.e. b(r) and B; and 2×(M+jₘₐₓ)×n+2×R+2 real variables. If the formulation uses fitted aᵢ's then this adds kₘₐₓ×n real variables. Recall however from the above discussion (Events and Probabilities) that usually iₘₐₓ<<n so the number of real variables is 2×(M+jₘₐₓ+k)×iₘₐₓ+2×R+2

The main real variables are the weights g_{i,j} on the linear functionals L_{i,j} describing the price function for the contract. Note that all the v's in the formulation above are constants.

### EXAMPLE

Here we present a worked example where we investigate the difference in expected contract price between an emphasis on the Provider's utility or on the Client's utility. When we emphasize the Provider's utility the resulting prices are basically cost plus margin, resulting in a high range of different unit prices for the same volume, which is undesirable to the Client. When we emphasize the Client's utility we obtain linear price versus volume curves but the Provider's margin has significant uncertainty. The Provider's value at risk (VaR) type condition on the margin distribution means that the expected price for the contract is higher and we quantify this.

In this example we demonstrate the practical implementation of the method developed above (see “Method” section above) and show how the formulation can be written to take advantage of the fact that limited history dependence enables a compact representation of the state space of prices. This in turn enables a reduction in the number of basis functions required to represent prices.

Events and Probabilities—SARMA demand: We consider contract lengths ranging from 2 to 10 years with monthly measurement/billing, i.e. n=24, . . . , 120.

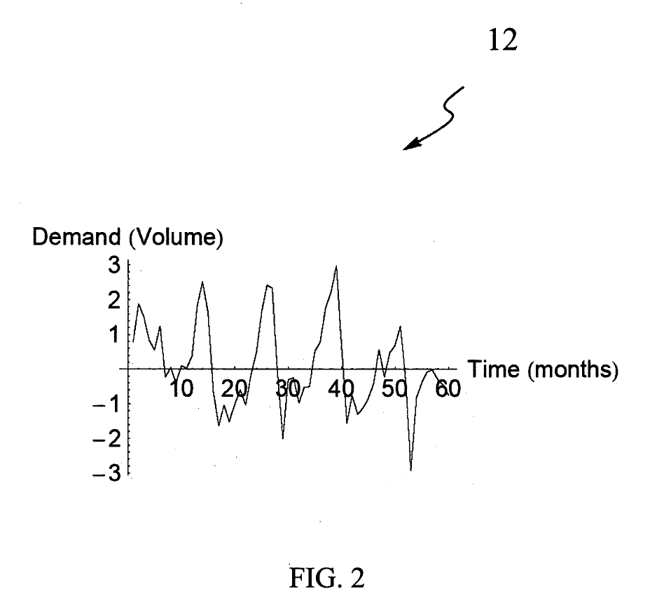

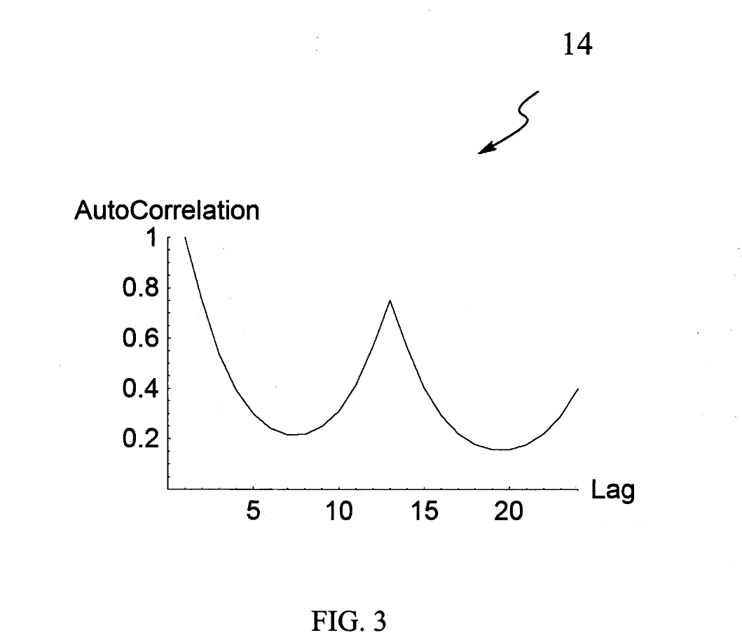

We assume the same demand, for all examples: a constant mean with the variation around the mean described by a SARMA process with yearly seasonality. We define the volume range as used in the rest of the example as [0,8] and the mean demand as 4 (arbitrary) units. FIG. 2 (numeral 12) shows the de-mean'd series for n=60, and FIG. 3 (numeral 14) its autocorrelation (note the yearly seasonality). If we had SARIMA demand then with sufficient differencing we could achieve demand that was SARMA. Typical non-stationarities include linear and quadratic forecasts of future business growth. What follows can be adapted directly for the SARIMA case (note that the state space for costs and prices is independent of the demand function) but we present the SARMA case for simplicity.

Costs and Prices

Costs

We are primarily interested in IT and BP outsourcing so we will give a set of example cost breakdowns that cover a suitable range. This is at a fairly high level of abstraction since, for example, a large scale outsourcing deals may depend on literally millions of pieces of data.

Constant: costs are fixed and have no variable portion, e.g. multi-processor machine installed, at Client site with a variable number of processors active (and billed for) depending on load.

Linear: costs are linearly proportional to usage (and ideally with no fixed portion) e.g. storage used from a remote storage utility where the Provider only has to pay for actual storage used by the Client.

Granular: costs come in pre-defined quantities that are non-divisible e.g. floating variable software licenses where the Provider only has to pay the third-party software supplier based on the number of licenses in use (per billing period).

Granular+Change: granular costs that also have one-off costs for service level change, e.g. hardware (boxes) with installation costs or removal penalties.

Granular+Lag+Change: granular costs that are only change at some time after the requirements change which may have non-zero associated point costs, e.g. people—for example software engineers assigned to a Client as part of Application Management Services where training is required before the person becomes effective; also present when a notice period is required before removing people (with penalty payments).

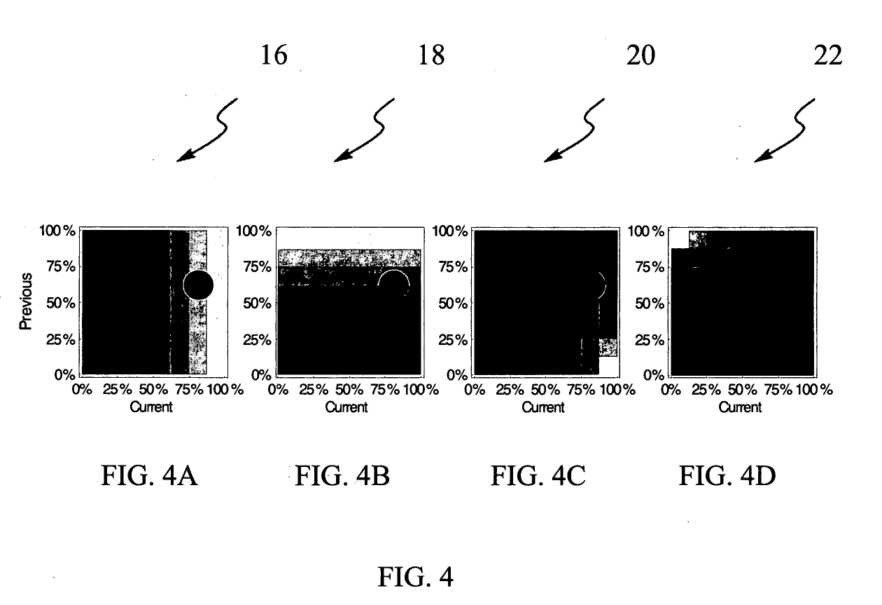

We consider four variations of a granular cost structure: Granular; Granular+Lag; Granular+Change; Granular+Change+Lag. We consider granularities of 12.5% of the demand range, 25% of the range, 50% of the range and 100% which corresponds to case 1 above (Constant costs). We consider single period lags in the examples. Thus the relevant cost state space is Markov and two-dimensional and we label the state axes of current demand volume and previous demand volume as (Current, Previous). FIG. 4 (numerals 16, 18, 20, 22) shows examples of the cost maps for these cases with cost granularity of 12.5% of the demand range. FIG. 4A (numeral 16) illustrates the Granular cost state space example; FIG. 4B (numeral 18)—Granular+Lag; FIG. 4C (numeral 20)—Granular+Change; FIG. 4D (numeral 22)—Granular+Change+Lag. Unit cost per demand, unit change costs, and unit lag are used. In the Change+Lag example the change costs are calculated as occurring immediately and the unit costs have unit lag. Axes are percent of volume range.

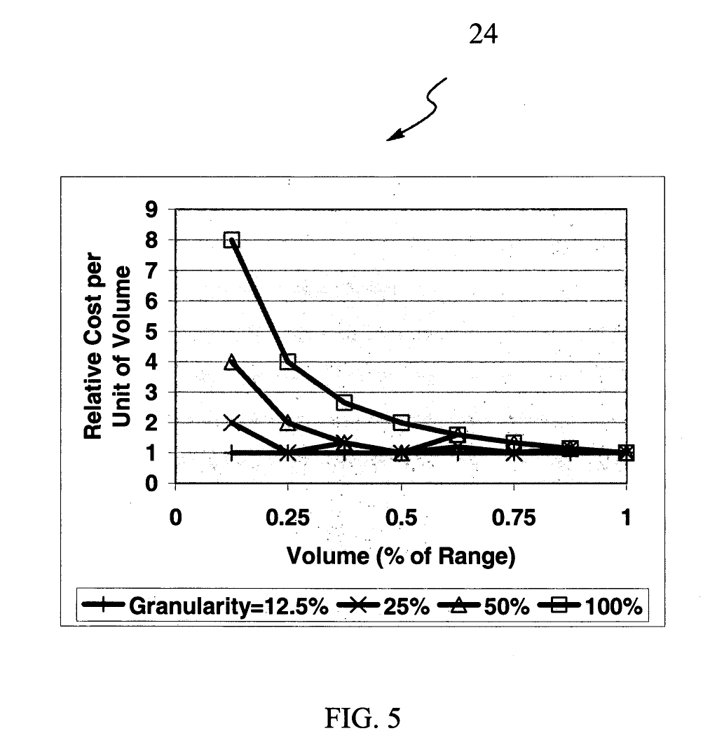

We define the demand range below. FIG. 5 (numeral 24) shows the resulting cost per unit for the four different cost granularities that we examine where the cost to change delivery level is zero. When the cost to change delivery level is non zero the cost per unit is then history dependent. In FIG. 5, we assume unit that a single unit (12.5% of the volume range) has unit cost, and consider a range of change costs from zero through four times the unit cost. At one extreme this could be the administration costs for de/allocating remote processors and at the other fixed costs associated with new facilities.

Prices

We define prices over a two dimensional state space (Current volume, Previous volume) where we use state expansion to obtain a Markov situation. State expansion is a standard technique to move non-Markov situations to Markov ones (Ross 2002). Thus we remove the history dependence in the prices, i.e. instead being functions of L_{i,j} where i=1, . . . , n prices are functions of L_{i,j} where i=1, 2 but now the i index is related to the dimension of the Markov state space and not to the history. i=1 is used for Current volume and i=2 is used for Previous volume. We still require the j=1, . . . , jₘₐₓ basis functions for full price generality (relative to costs). If we wanted time (but not history) dependent prices then we would have i=1, . . . , 3 where the third index would be used for time. We use piecewise constant unit prices defined over a chessboard-like decomposition of the 2-dimensional state space, i.e. jₘₐₓ=64. Thus we have piecewise linear state prices. We divide up the demand volume range into 8 equal parts (so we have 64 basis functions, each non-zero over a 12.5% by 12.5% region of the state space).

Implementation

The formulation was programmed in GAMS 21.3 (GAMS Development Corporation 2004) using the Cplex 9.0 MIP, and QCMIP solvers (ILOG 2004). Running times were of the order of minutes with optcr=0.05, i.e. solving to within 5% of optimality.

### Results

We first look at the optimal contract price design frontier, i.e. the tradeoff between Client and Provider utility. After this we go into details examining the effect of contract length, cost granularity, and cost to change delivery level on total expected contract price.

Finally we show the overall empirical relationship between the variation of Provider margin versus the additional contract cost to have Linear prices.

Throughout these examinations we compare costs of different pricing schemes that can be selected by setting the weights in the Client and Provider utility functions. The three pricing schemes we concentrate on are: Cost Plus (zero margin variation for Provider, history dependent prices for Client; Linear price per volume (i.e. constant unit price for Client and margin variation for Provider); and an intermediate state which we call Certain, i.e. no history dependence in prices but the prices are not required to be linear with volume (i.e. fixed unit prices but not necessarily equal for different volumes).

We set parameters as follows:

wₚ=wᵣ=1, thus Client and Provider weigh expected contract price and return equally; ξ=Ξ=α, i.e minimum margin threshold is also used for Provider utility minimum and up/downside risk anchor point;

wₕ=0 upside carries no particular benefit (note that the expected return is already valued);

β=10%, so only 10% of contract histories may have a return of less than β wₜ=∞, no violation of the rule above is permitted.

We move between Cost Plus and Linear pricing by setting for the former case w_{d}=wₛ=0, wₜ=10; and for the latter w_{d}=wₛ=10, wₜ=0. Note that in the actual implementation it is very important to make sure that all the scalings of the different terms are appropriate. For Certain prices we use the w_{d}=10, wₛ=0=wₜ=0, i.e. prices should not vary with history. We also set aᵢ to be a variable and not a constant and make it a function of the current volume only, i.e. it has the form aᵢ(vᵢ^{m})

Pareto-Optimal Price Design Frontier

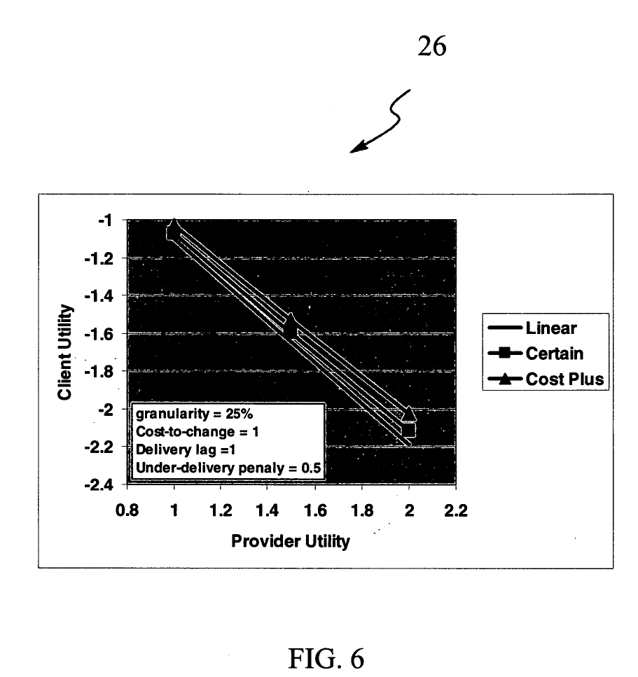

The tradeoff between Client utility and Provider utility is shown in FIG. 6 (numeral 26) for three different price designs: Linear; Certain; and Cost Plus. These are for 25% cost granularity and unit cost to change as specified on the figure. Note that the frontiers do not cross, i.e. for a given set of preferences the resulting price design does not change. Different price designs result from different preferences at coded into the formulations with the w's as specified above. The frontiers are created by scanning across a range of ξ, i.e. minimum Provider utility (approximately equal to the return=price/cost), from ξ=1 to ξ=2. Note with respect to FIG. 6 that frontiers achieved with different utility weights are not direct alternatives because they are derived from different preferences.

Contract Length

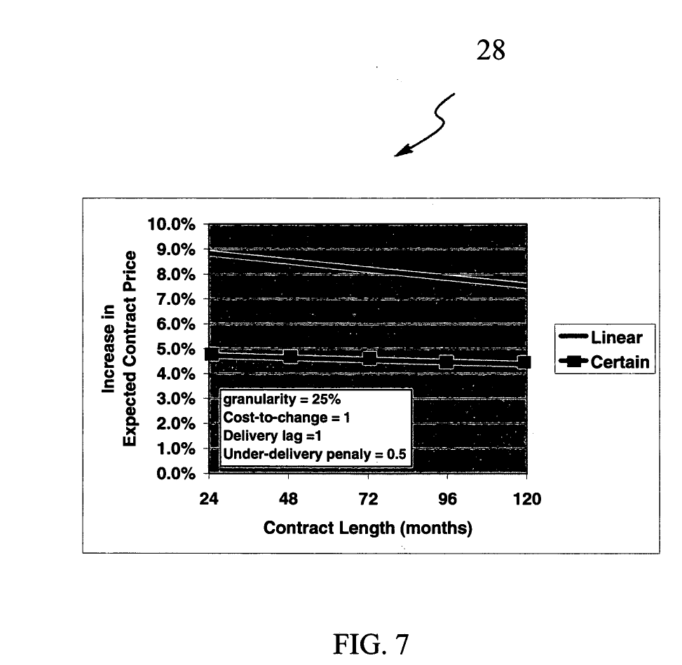

We consider contract lengths from 2 to 10 years with monthly measurement/billing. For each contract length, FIG. 7 (numeral 28) compares the expected total contract price for Linear prices and Certain prices with that for Cost Plus prices. Cost Plus prices are always the cheapest because the Provider margin constraint is automatically satisfied, i.e. does not require any change in expected price. Again we consider a specific contract instance with significant cost granularity, non zero cost to change delivery level, and lagged fulfillment. Whilst details differ for different specifications FIG. 7 illustrates a two general points. Firstly the change in expected contract price decreases with contract length for both Linear and Certain prices. This is related to the change in the coefficient of variation of the cost for different contract histories. The longer the contract the smaller the coefficient of variation. This is generally true for demand processes that have autocorrelations that decrease (even if seasonality is present). Secondly Linear pricing is more expensive than certain pricing simply because it is a more constrained pricing scheme.

Price Versus Volume

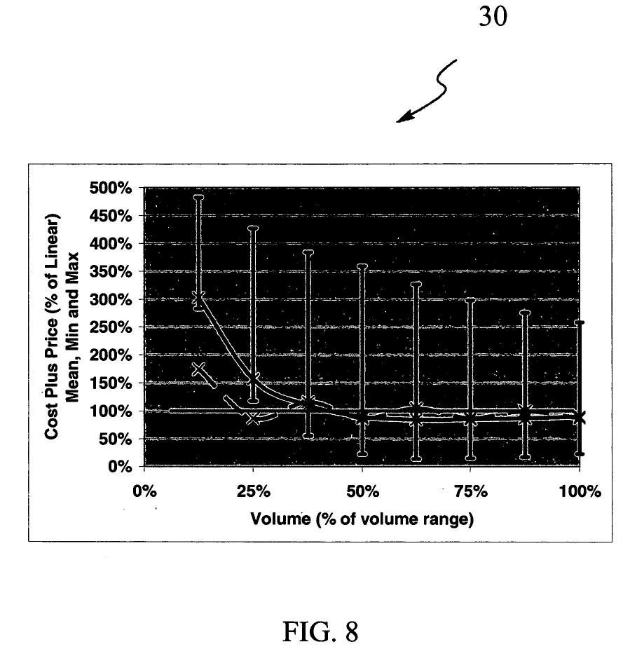

What is the range of prices, that a Client could observe with Cost Plus pricing? This will describe the attraction of Linear or Certain prices. (Note that Certain and Cost Plus prices are the same when cost has no history dependence, i.e. here, where cost to change delivery level is zero). FIG. 8 (numeral 30) illustrates the optimal price per unit as a function of volume for cost granularity of 25% for zero cost to change, and for cost to change 4× unit cost (the dashed line and the curve with error bars, respectively, in FIG. 8). The error bars (associated with the curve representing cost to change 4× unit cost in FIG. 8) give the range of unit prices that a Client would observe. Clearly this range is zero when the cost to change is zero (dashed line in FIG. 8). Prices are compared to optimal Linear prices (horizontal cost per unit line at 100%). In these situations optimal prices for Cost Plus are highly non-linear and, for the non-zero cost to change case, highly unpredictable from volume alone. Additionally these prices can be both above and below the optimal Linear prices. Thus we can imagine that when there is even some cost granularity or cost to change deliver levels Linear prices will be qualitatively attractive. In the next section we detail their quantitative consequences for expected contract prices.

Cost Granularity and Cost to Change Delivery Level

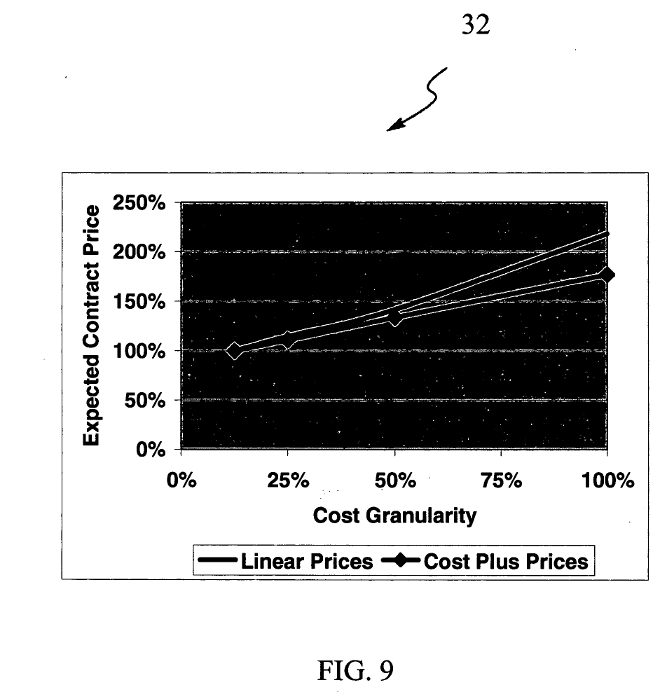

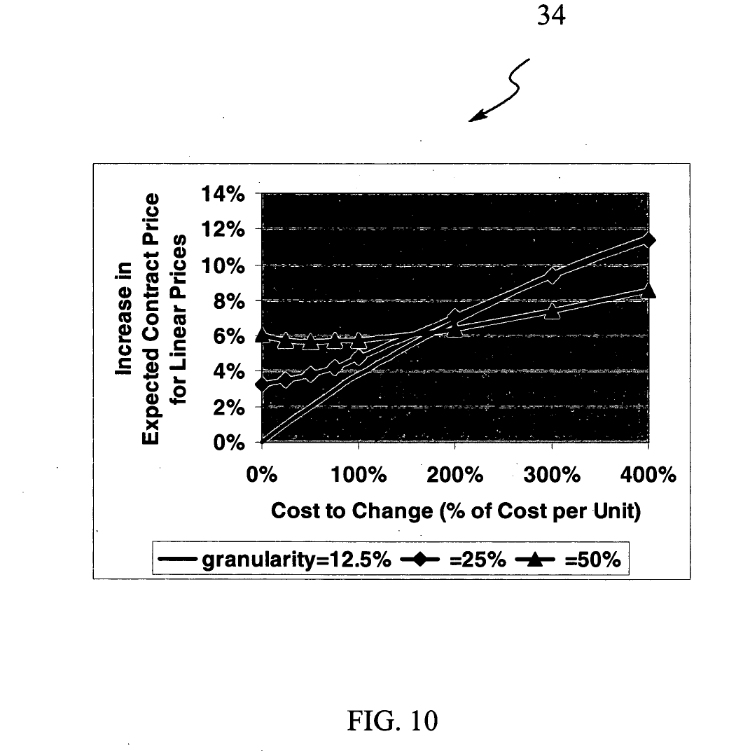

Here we examine the quantitative expense (change in expected contract price) to the Client for Linear prices that achieve equal Provider utility. We show this for cost granularity in FIG. 9 (numeral 32) and the effect of cost to change in FIG. 10 (numeral 34). FIG. 9 illustrates expected contract prices with optimal Cost Plus prices and optimal Linear prices. Cost Plus is always cheaper because the Provider VaR-type constraint on margin distribution is trivially satisfied. With Linear prices the margin distribution has a width and so there is a cost to fulfill this constraint. FIG. 10 illustrates dependence of expected contract price on the cost to change the delivery level for Linear pricing relative to Cost Plus price. Recall that a difference in expected contract price of a few percent can be significant for contract negotiation and always for profits in outsourcing deals which typically range from 50M (Euro or Dollars) to small numbers of billions. If Linear prices are required these Figures quantify the percentages involved. These range from zero (obviously for no granularity and no cost to change) through 5% for significant levels of both to 20% for cases where costs are fixed (e.g. IT equipment at Client site, such as large computing capacities).

Margin Uncertainty as Difference Driver

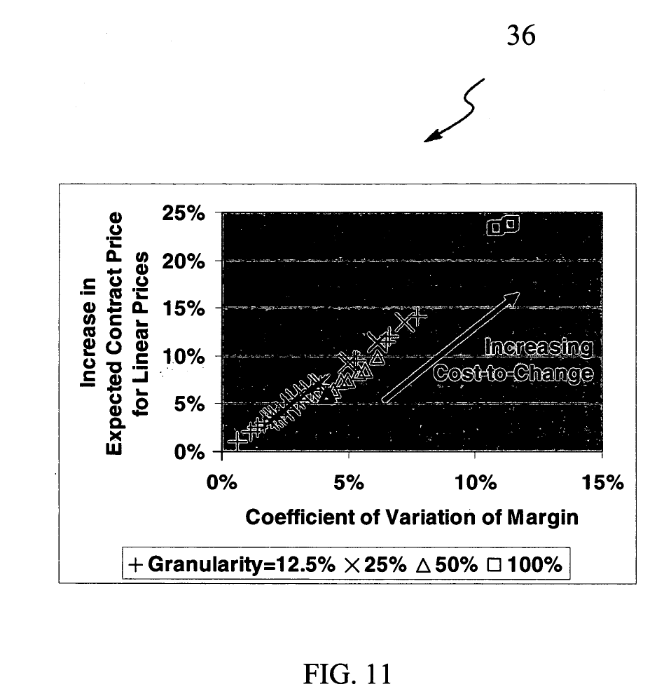

Here we synthesize all the different cases examined and illustrate the relationship between the coefficient of variation (CoV, which equals standard deviation/mean) of the Provider margin and the expected increase in expected contract price, see FIG. 11 (numeral 36). For, the weights we have chosen to generate the different cases, there is a fairly linear relationship between these two variables. Linear pricing costs roughly two times the Provider CoV. In FIG. 11, all test cases discussed above are shown, e.g., different costs to change, zero lag and unit lag.

It is somewhat surprising at first glance that cost granularity and cost to change have so little effect on the slope in FIG. 11. In fact the linear relationship depends most strongly on two factors: the VaR type constraint in the Provider utility function—as this varies so does the slope; and secondly on the shape of the margin distribution—as this varies so will the slope. Thus the slope will not be the same for different values of β nor will it be the same for very different demand processes. Here the length of the contract will be Important in moving the sum of the prices and costs at different billing/measurement points towards a Normal distribution. However the speed at which this happens versus the change in contract length will depend on the details of the circumstances, as a person of ordinary skill in the art will recognize.

### Discussion

Here we characterized and solved the price design problem (PDP) for variable capacity IT/BP outsourcing contracts within a descriptive multi-attribute utility theory framework from the point of view of the bid team, i.e. they know costs and must negotiate prices. In these situations costs are usually granular, non-linear, and history dependent. We motivated and described typical utility functions for both the Provider and the Client and showed that these can cover a range of price designs from Cost Plus through Certain (i.e. non-linear but not history dependent) to Linear prices (with—or without—zero intercept, i.e. zero cost for zero volume).

We showed that the price design problem, i.e. the general problem of choosing a price structure to optimize the joint utility function of the Provider and of the Client for arbitrary cost functions, can be formulated exactly as a stochastic program. This formulation imposes no restrictions on the form of the price functions a priori. We introduced a formulation method based on decomposition of the event space (where events are, e.g. Client requirement histories) using a basis of linear functionals. Depending on the form of the utility functions we showed that the price design problem: was reducible to a Stochastic Linear Program (SLP); a Stochastic Linear Mixed Integer Program (SLMIP); or to a Stochastic Quadratic Mixed Integer Program (SQMIP). These can be solved numerically for real-world instance sizes using standard software. The solution yields Pareto-efficient outcomes with respect to the Provider and the Client. The frontier of Pareto-optimal designs serves as an appropriate space for practical contract negotiation.

The method presented includes probabilistic techniques; it will be apparent to a person of ordinary skill in the art that in general it would be useful to augment these with non-probabilistic techniques, to deal with cases where there it is difficult to obtain an accurate specification of the probability space. To scale to very large problem sizes more attention should be placed on the basis functions for the prices and to their iterative refinement. This is a well known problem type—basis functions refined only where required. In this direction any basis functions and iterative refinement technique could be used as a starting point, e.g. iterative refinement of b-splines (Forsey& Bartels 1988).

Our numerical results are, of course, illustrative in that we consider a specific range of cost structures, contract length, and preferences (utility function weights) for the Provider and Client. The method of the invention, however, is not limited to the specific illustrations provided, as the invention provides a very general method to quantify utilities and obtain optimal prices. Certain points are suggested, however, in conjunction with the form of the utility functions and constraints. Linear prices will clearly always be more expensive than Certain or Cost Plus prices. However, there is little dependence on contract length even for significant long range correlation in the demand process (here yearly seasonality). Cost granularity is a significant price driver: note for example that the vertical scale in FIG. 9 has a range of 100% and we see expected contract price differences of up to 20%. Admittedly this last is for the case of fixed costs but is relevant for, say, installing a mainframe charged as a utility. Even for 25% granularity, in FIG. 9 we see a 3% difference in expected contract price, which is significant when contracts may be negotiated down to the last percentage point (or less). Non-zero, costs to change delivery levels accentuate the picture. However, those of ordinary skill in the art should recall that typical outsourcing contracts involve many different items with different levels of granularity and costs to change, so the actual situation will be an average over the different delivery towers comprising the BP or IT service.

On what time-scales is it realistic to add and remove capacity for different potential contract items? That is, can costs really change over contract lifetimes. We focus on BP/IT outsourcing (2 to 10 year contracts), so the items range from facilities (HVAC, buildings) and hardware (discs, processors, networks, PC's, servers, mainframes), through software (licenses), to people (maintenance, application programmers, specialists carrying out BP steps). We also need to take into account the management effort required to support changes: even if it is possible to change things in certain ways operationally it may not be practical to do so. A good example is building space—in theory it can be rented by the square meter for the day, in practice it comes in, say, 100 or 1000 square meter units for months. In addition in many outsourcing contracts a large majority of items are measured and billed on a monthly cycle.

Items with the finest and most responsive capacity delivery are generally commodities delivered from off-site with utility prices to the Provider. Examples include electricity, hard disc storage in units of 1 GB), processing capacity (sometimes depending on the application) in units of 1 processor, and wide area network capacity (sometimes), etc. Software licenses can fall into this category but in fact span the complete range with fixed site or enterprise license costs at the other extreme. PC costs can be changeable on a monthly basis and usually also have associated change costs. Servers are further away depending on their size, and mainframes on site are almost at the same level as dedicated physical facilities (which they may also use) in terms of granularity of costs and timing. People usually come in integer units (rather than percent utilization) in contracts but generally may be added and subtracted with a large variety of different conditions (lags, notice periods, penalties) depending on the situation and also on country-specific details. Lagged responses are usual when special training or relocation is required. However the degree of lag depends on how the contract is managed and the degree to which variations in demand are predictable.

We now comment on under delivery, i.e. when delivery of capacity is less than required. Clearly prices should be set according to the minimum of requirements and delivery (and their history as appropriate). The utility function of the Client may ignore such under delivery, given that it might be a function of the underlying capacity supply mechanism and should never be a surprise in practice. That is, the Provider knows the situations in which under delivery will occur and has informed the Client, equivalently the Client may choose this type of delivery for good commercial reasons. However, under delivery becomes important for the Client when it compares different combined delivery/price schedules (possibly from different Providers using different technologies). Thus we have included it in the Client utility function. It is also important to the Provider in as much as under delivery, although expected, may lead to explicit penalty payments.

In conclusion, we characterized and solved the price design problem (PDP) for variable capacity IT/BP outsourcing contracts from the point of view of the bid team, i.e. they know costs and must negotiate prices. We motivated and described typical utility functions for both the Provider and the Client. We showed that the price design problem can be formulated exactly as a (linear or quadratic, integer) stochastic program. This formulation imposes no restrictions on the form, or on the history dependence, of the cost or price functions a priori and is based on a decomposition of the event space using a basis of linear functionals.

The methods in accordance with the present invention may therefore be implemented at least partially using software, e.g., computer programs, and the invention may provide computer software specifically adapted to carry out the methods described above when installed on data processing means. The present invention may be embodied as a computer program product for use with a computer system. Such an implementation may comprise a series of computer readable instructions either fixed on a tangible medium, such as a computer readable medium, or transmittable to a computer system, via a modem or other interface device, over either a tangible medium such as optical or analogue communications lines, or intangibly using wireless transmission techniques. The series of computer readable instructions embodies all or part of the functionality previously described herein.

Although illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

### Appendix: L¹ Formulation

Here we give the L¹ formulation that leads to a SLMIP optimization that we used to obtain the results in the Example section above.

For the L¹ norm the volume and time deviation terms are:

$${x}_{m , i} \geq {p}_{i} ( {\underline{v}}_{i}^{m} ) / {v}_{i} - {a}_{i} ( {\underline{v}}_{i}^{m} )$$

$${x}_{m , i} \geq {a}_{i} ( {\underline{v}}_{i}^{m} ) - {p}_{i} ( {\underline{v}}_{i}^{m} ) / {v}_{i}^{m}$$

$$X = \frac{1}{M} {\sum }_{m = 1}^{m = M} {\sum }_{i = 1}^{i = n} {x}_{m , i}$$

$${y}_{m , i} \geq {p}_{i} ( {\underline{v}}_{i}^{m} ) / {v}_{i} - {p}_{i + 1} ( {\underline{v}}_{i + 1}^{m} ) / {v}_{i + 1}$$

$${y}_{m , i} \geq {p}_{i + 1} ( {\underline{v}}_{i + 1}^{m} ) / {v}_{i + 1} - {p}_{i} ( {\underline{v}}_{i}^{m} ) / {v}_{i}^{m}$$

$$Y = \frac{1}{M} {\sum }_{m = 1}^{m = M} {\sum }_{i = 1}^{i = n - 1} {y}_{m , i}$$

The result of expanding the price functions and incorporating into the main optimization formulation is shown below.

$${max}_{{g}_{i , j}} \frac{1}{M} {\sum }_{m = 1}^{m = M} {\sum }_{i = 1}^{i = n} {\sum }_{j = 1}^{j = {j}_{max}} {g}_{i , j} {L}_{i , j} ( {\underline{v}}_{i}^{m} ) + {w}_{d} X + {w}_{s} Y$$

$$s . t$$

$$X = \frac{1}{M} {\sum }_{m = 1}^{m = M} {\sum }_{i = 1}^{i = n} {x}_{m , i}$$

$${x}_{m , i} \geq {\sum }_{j = 1}^{j = {j}_{max}} {g}_{i , j} {L}_{i , j} ( {\underline{v}}_{i}^{m} ) / {v}_{i} - {a}_{i} ( {\underline{v}}_{i}^{m} )$$

$${x}_{m , i} \geq {a}_{i} ( {\underline{v}}_{i}^{m} ) - {\sum }_{j = 1}^{j = {j}_{max}} {g}_{i , j} {L}_{i , j} ( {\underline{v}}_{i}^{m} ) / {v}_{i}^{m}$$

$$Y = \frac{1}{M} {\sum }_{m = 1}^{m = M} {\sum }_{i = 1}^{i = n - 1} {w}_{m , i}$$

$${y}_{m , i} \geq {\sum }_{j = 1}^{j = {j}_{max}} {g}_{i , j} {L}_{i , j} ( {\underline{v}}_{i}^{m} ) / {v}_{i} - {\sum }_{j = 1}^{j = {j}_{max}} {g}_{i + 1 , j} {L}_{i + 1 , j} ( {\underline{v}}_{i + 1}^{m} ) / {v}_{i + 1}^{m}$$

$${y}_{m , i} \geq {\sum }_{j = 1}^{j = {j}_{max}} {g}_{i + 1 , j} {L}_{i + 1 , j} ( {\underline{v}}_{i + 1}^{m} ) / {v}_{i + 1}^{m} - {\sum }_{j = 1}^{j = {j}_{max}} {g}_{i , j} {L}_{i , j} ( {\underline{v}}_{i}^{m} ) / {v}_{i}^{m}$$

$${w}_{r} \frac{1}{M} {\sum }_{m = 1}^{m = M} {\sum }_{i = 1}^{i = n} {\sum }_{j = 1}^{j = {j}_{max}} {g}_{i , j} {L}_{i , j} ( {\underline{v}}_{i}^{m} ) - {w}_{i} B - {w}_{l} L + {w}_{h} H \geq ξ$$

$$L = {\sum }_{r = 1}^{r = R} {l}_{r}$$

$$H = {\sum }_{r = 1}^{r = R} {h}_{r}$$

$$Ξ = {l}_{r} - {h}_{r} + \frac{{\sum }_{i = 1}^{i = n} {\sum }_{j = 1}^{j = {j}_{max}} {g}_{i , j} {L}_{i , j} ( {\underline{v}}_{i}^{r} )}{{\sum }_{i = 1}^{i = n} {c}_{i} ( {\underline{v}}_{i}^{r} )}$$

$${l}_{r} \geq 0$$

$${h}_{r} \geq 0$$

$$B ⨯ BIG \geq - β + \frac{1}{R} {\sum }_{r = 1}^{r = R} b ( r )$$

$$b ( r ) ⨯ BIG \geq α - \frac{{\sum }_{i = 1}^{i = n} {\sum }_{j = 1}^{j = {j}_{max}} {g}_{i , j} {L}_{i , j} ( {\underline{v}}_{i}^{r} )}{{\sum }_{i = 1}^{i = n} {c}_{i} ( {\underline{v}}_{i}^{r} )}$$

$${\sum }_{j = 1}^{j = {j}_{max}} {g}_{i , j} {L}_{i , j}^{′} ( {\underline{v}}_{i}^{r} ) \geq 0 ∀ i = 1 , … , n , ∀ r = 1 , … , R$$

The last equation above describes the no-arbitrage price constraints as implemented at a random set of discrete points in Eᵢ and we define L′_{i,j}=∂L_{i,j}/∂vᵢ. Note that in the examples we presented we found that this last constraint was not required as it was automatically obeyed. However it is possible to generate examples where it is required.

1. A method suitable for generating a legal contract between an offeror and an offeree, the method comprising the steps of:
(i) determining a contractual attribute utility function based on offeror preferences;
(ii) determining a contractual attribute utility function based on offeree preferences; and
(iii) generating a legal consideration profile by correlating the attribute utility functions based on both the offeror and offeree preferences.

2. A method according to claim 1, wherein at least one of the offeror and offeree preferences comprises pricing.

3. A method according to claim 2, wherein the pricing comprises utility pricing.

4. A method according to claim 1, wherein at least one of the offeror and offeree preferences comprises certainty in order to achieve a predetermined profit margin.

5. A method according to claim 1, wherein at least one of the offeror and offeree preferences comprises variable capacity information technology infrastructure.

6. A method according to claim 1, wherein at least one of the offeror and offeree preferences comprises variable capacity business processes.

7. A method according to claim 1, wherein at least one of the offeror and offeree preferences comprises specifying a delivery method.

8. A method according to claim 1, wherein at least one of the offeror and offeree preferences comprises specifying a contractual item.

9. A method according to claim 1, wherein step (iii) correlating comprises generating a legal consideration structure relative to the utility functions at least one of offeror and offeree preferences.

10. A method according to claim 9, wherein the legal consideration structure comprises at least one of a pricing structure and a delivery structure.

11. A method according to claim 9, wherein step (iii) correlating comprises employing a descriptive multi attribute utility theory framework.

12. A method according to claim 1, wherein step (iii) comprises correlating the attribute utility functions based on history dependency.

13. A program storage device readable by machine, tangibly embodying a program of instructions executable by the machine to perform a method suitable for generating a legal contract between an offeror and an offeree, the method comprising the steps of:
(i) determining a contractual attribute utility function based on offeror preferences;
(ii) determining a contractual attribute utility function based on offeree preferences; and
(iii) generating a legal consideration profile by correlating the attribute utility functions based on both the offeror and offeree preferences.
